(19) United States
(12) Patent Application Publication
(10) Pub. No.: US 2002/0044651 A1
(43) Pub. Date: Apr. 18, 2002

(54) Method and apparatus for improving the security of cryptographic ciphers

(76) Inventor: Walter E. Tuvell, Reading, MA (US)

Correspondence Address: KUDIRKA & JOBSE, LLP, ONE STATE STREET, SUITE 1510, BOSTON, MA, 02109, US

(21) Appl. No.: 09/852,499

(22) Filed: May 10, 2001

Related U.S. Application Data
(60) Provisional application No. 60/204,510, filed on May 16, 2000.

(51) Int. Cl. H04K 1/04

(52) U.S. Cl. 380/37

(57) ABSTRACT

The security of block cipher counter mode of operation can be improved, and stream ciphers can be converted to a “block-like” (stateless) mode of operation, by using a modified key which is a fixed secret key (K) combined with a varying random non-secret byte sequence (J) with same size as the keysize of key K. In accordance with various embodiments, the modified key can be generated by XORing the fixed secret key with a varying random sequence that is newly generated for each plaintext message. Alternatively, the fixed secret key can be modified with a variable, non-secret initialization vector and used with stream ciphers. In still another embodiment, the key and sequence are concatenated and passed through a mask generation function.

### RELATED APPLICATIONS

This application is related to, and claims priority under 35 U.S.C. §119(e) of, provisional patent application No. 60/204,510 entitled CRYPTOGRAPHIC CIPHERS WITH IMPROVED SECURITY, filed on May 16, 2000 by Walter Tuvell.

### FIELD OF THE INVENTION

This invention relates to cryptography and, in particular, to counter mode block cryptographic ciphers and stream ciphers.

### BACKGROUND OF THE INVENTION

Cryptographic ciphers are functions that map plaintext to ciphertext in a process called “encryption” under control of an encryption key, and map ciphertext to plaintext under control of a decryption key in a process called “decryption”. The discussion below considers only so-called “symmetric” ciphers, wherein the same key is used for both encryption and decryption. Conventionally, cryptographic ciphers come in two types: block ciphers and stream ciphers.

Block ciphers operate with a data “block”, which is a data piece of fixed size called a “blocksize” (which is a number of bytes of data, typically 8 or 16). In the raw or “naive” mode of operation, these ciphers map a block of plaintext to a block of ciphertext, and vice versa. Block ciphers are inherently “stateless”—the encryption and decryption of a particular data block does not depend on the results of the encryption or decryption of any other data block. The stateless nature is convenient, but these ciphers are too limiting, because most plaintext has a size other than a blocksize or an even multiple of a blocksize. Therefore, some additional technology must be used to deal with non-blocksize plaintexts. That technology is called “modes of operation” which essentially “transform” block ciphers into stream ciphers.

To date, there are six generally accepted modes of operation in common use with block ciphers: Electronic Code Book (ECB), Cipher Block Chaining (CBC), Cipher Feedback Mode (CFB), Output Feedback Mode (OFB), Cipher Text Stealing (CTS) and Counter Mode (CM). The last, Counter Mode, is of interest here. The operation of a block cipher in Counter Mode is described as follows.

Let X be a block cipher, of blocksize B bytes, and let K be a key (the key has some keysize, not necessarily the same as the blocksize). Then, under the control of the key, K, the block cipher X maps any plaintext block, P, into a ciphertext block as indicated by:

Q=X(K,P).

Now consider a plaintext message, M, of any length, which is to be encrypted. By definition, the CM ciphertext message N=X_{CM}(K,I,M) is formed as follows:

(i) first, write the plaintext message M as a sequence of n bytes:

M₀, M₁, M₂, . . . , Mₙ₋₁

(ii) randomly choose an initialization vector, 1, for the message (this initialization vector must be communicated between communicating parties, but need not be kept secret), of size equal to the blocksize of X.

(iii) view I as a blocksized integer (of size B bytes=8*B bits), via a “big-endian” mapping (the leftmost byte is the most significant); this integer is the starting point of our “counter.”

(iv) let k be the smallest integer such that B*k≧n, and form the following sequence of k blocksized integers:

I+0, I+1, I+2, . . . I+(k−1)

Here, “+” denotes integer addition (unsigned, modulo 2^{8*B}).

(v) next, encrypt those blocksized integers (viewed as blocks, again via the big-endian mapping), resulting in the following sequence of k blocks:

X(K,I+0), X(K,I+1), X(K,I+2), . . . , X(K,I+(k−1))

(vi) view those k blocks as B*k bytes of encrypted integers:

X(K,I+0)₀, . . . , X(K,I+0)_{B-1},

X(K,I+1)₀, . . . , X(K,I+1)_{B-1},

X(K,I+2)₀, . . . , X(K,I+2)_{B-1},

. . . ,

X(K,I+(k−1))₀, . . . , X(K,I+(k−1))_{B-1}

(vii) finally, the sequence of bytes <N₀, N₁, N₂, . . . , Nₙ₋₁> of the ciphertext message, N, is calculated by XOR'ing the consecutive bytes of the plaintext message <M₀, M₁, M₂, . . . , Mₙ₋₁> with the consecutive bytes of the encrypted integers calculated in step (vi):

Nⱼ=Mⱼˆ X(K,I+[j/B])_{{j/B}} for 0≦j≦n−1

Here, “ˆ ” denotes bitwise XOR (of bytes); “[j/B]” denotes the largest integer ≦j/B; and “{j/B}” denotes the integer (in the range 0 . . . B−1) that satisfies the equation j=[j/B]*B+{j/B}.

Counter Mode operation has two convenient advantages that are not shared by the other block cipher modes of operation. First, it's conservative, meaning that the ciphertext retains the message size of the plaintext, without expansion, for all messages. Second, it's seekable or can be accessed randomly, meaning any byte in the resulting data stream can be encrypted or decrypted without encrypting/decrypting the previous or succeeding bytes.

Unfortunately, Counter Mode is considered insecure, because it is susceptible to an “XOR attack”. Specifically, if two messages are encrypted with the same key and colliding or overlapping initialization vectors, then the two ciphertext messages can be XORed and the encrypted integer portions which are part of each ciphertext cancel out, leaving a remainder that is just the XOR of the two plaintexts. This remainder is relatively easy to cryptanalyze (it “leaks information” easily). If an initialization vector is chosen randomly for each message, two such colliding or overlapping initialization vectors can be expected after encrypting only sqrt ((π/2)*(2^{(8*B)})) blocks of plaintext with the same key. Therefore, the margin of security is not good.

An alternative to block ciphers is stream ciphers. Stream ciphers do not support a notion of block. In the raw or naive mode of operation, stream ciphers map any number of bytes (a “stream” of bytes) of plaintext to the same number of bytes of ciphertext, and vice versa. In particular, let Y be a stream cipher, and let K be a key (of some keysize). Then, under control of K, Y maps any plaintext message M of arbitrary length into a ciphertext message: N=Y(K,M) of the same length. This characteristic allows stream ciphers to deal with plaintext messages of varying length. However, stream ciphers have an inherent state, which means that the encryption and decryption of a particular byte in the stream depends on the results of encryption or decryption of a preceding or succeeding byte. Therefore, when using a stream cipher, both communicating endpoints must agree on their position in the stream. If either endpoint loses its position, some sort of re-synchronization protocol (which is computationally expensive) must be used to transmit a new position and reestablish communication.

### SUMMARY OF THE INVENTION

In accordance with the principles of the invention, the security of block cipher counter mode of operation can be improved, and stream ciphers can be converted to a “block-like” (stateless) mode of operation, by using a modified key which is a fixed secret key (K) combined with a varying random non-secret byte sequence (J) with the same size as the keysize of key K.

In accordance with one embodiment, the aforementioned block cipher operating in counter mode can thereby be changed to yield a “modified counter mode” (MCM) by using a modified key that comprises the fixed secret key used by the block encryption algorithm in the block cipher arrangement XORed with a varying random non-secret byte sequence (J). Here, J is a random byte sequence with the size of the secret key that is newly generated for each plaintext message. After the key has been modified, then the counter mode block cipher processing is applied as described above.

In accordance with another embodiment, a fixed secret key can be modified with a variable, non-secret initialization vector and used with stream ciphers. Specifically, a block-like modified stream cipher, called “block mode” is generated by combining a random byte sequence of keysize that acts as an initialization vector, with a fixed secret key K. The modified key is then used in a conventional stream cipher arrangement.

### BRIEF DESCRIPTION OF THE DRAWINGS

The above and further advantages of the invention may be better understood by referring to the following description in conjunction with the accompanying drawings in which:

FIG. 1 is a block schematic diagram illustrating a conventional counter mode block cipher arrangement.

FIG. 2 is a block schematic diagram illustrating how the conventional counter mode block cipher is modified in accordance with the principles of the invention,

FIG. 3 is a block schematic diagram illustrating a conventional stream cipher arrangement.

FIG. 4 is a block schematic diagram illustrating how the conventional stream cipher is modified in accordance with the principles of the invention.

FIG. 5 is a block schematic diagram illustrating the use of a mask generation function with a variable length initialization vector.

FIG. 6 is a flowchart showing the steps in an illustrative process for modifying the key used in the encryption process.

### DETAILED DESCRIPTION

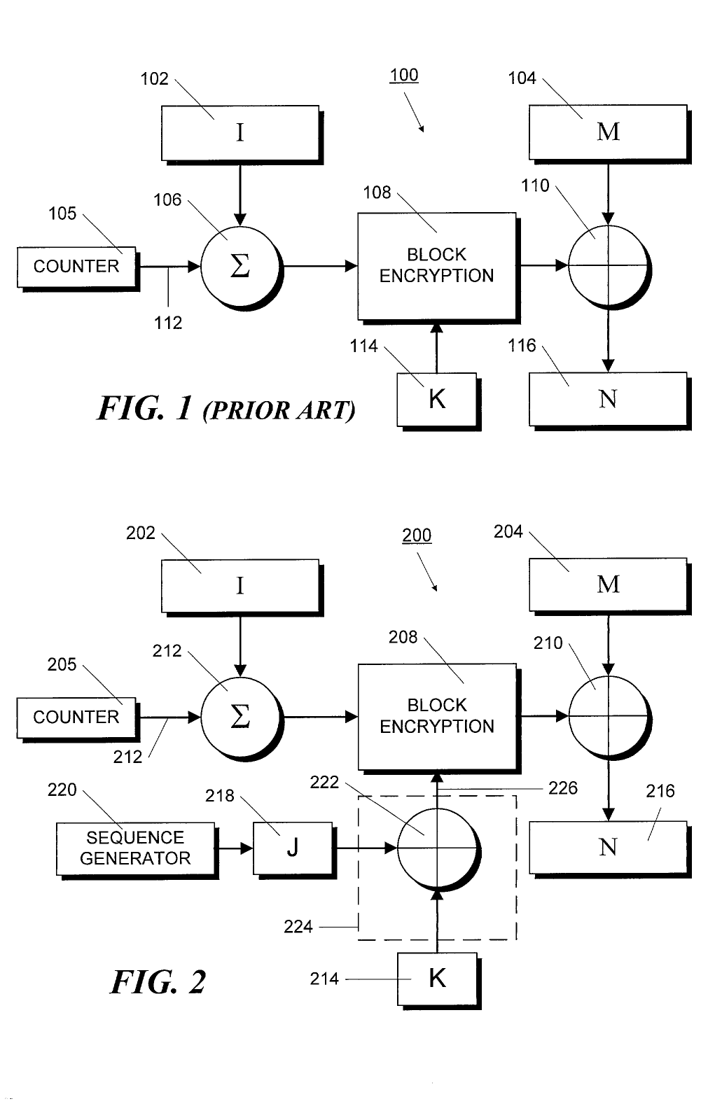

FIG. 1 shows, in schematic form, a conventional block cipher arrangement 100 using counter mode operation. The encryption arrangement 100 processes a plaintext message, M, of any length. The encryption is performed by any well-known block encryption algorithm 108 such as DES, AES (Rijndael), Twofish, RC6, MARS and Serpent, etc. Such an algorithm 108 typically processes an input data block with a predetermined blocksize B to produce an encrypted output with the same blocksize B.

In order to perform the counter mode processing, an initialization vector 102 is chosen for the entire plaintext message. The initialization vector 102 must be communicated between the sending party and the receiving party, but need not be kept secret. The initialization vector 102 has a length equal to the blocksize B of the encryption algorithm 108.

A sequence of the integer values (0, 1, 2, . . . ) 112 is generated by the counter 105. Each integer value is added to the initialization vector 102, as denoted by the addition operator 106, to produce a sequence of counter variables. The addition is unsigned integer addition modulo the blocksize B. The counter variables are then encrypted using the encryption algorithm 108 with a key K (114) as denoted by the arrows in FIG. 1. As previously described, bytes of the resulting encrypted vectors are combined with bytes of the plaintext message 104 by a bitwise exclusive-OR operation 110 to produce bytes of the ciphertext N (116.)

In accordance with the principles of the invention, the encryption arrangement shown in FIG. 1 can be improved by modifying the arrangement as shown in FIG. 2. In FIG. 2, elements that correspond to elements in FIG. 1 have been given corresponding numeral designations. For example, encryption algorithm 108 in FIG. 1 corresponds to encryption algorithm 208 in FIG. 2.

In particular, the aforementioned block cipher operating in counter mode can thereby be changed in accordance with the process shown in FIG. 6 to yield a “modified counter mode” (MCM) by using a modified key that comprises the fixed secret key 214 used by the block encryption algorithm 208 in the block cipher arrangement combined with a varying random non-secret byte sequence J (218). The process starts in step 600 and proceeds to step 602 where the random byte sequence is generated. Here, the J sequence 218 is a random byte sequence with the size of the secret key 214 that is newly generated for each plaintext message. This sequence 218 can be generated by a sequence generator 220 that might be a random number generator, a pseudo-random number generator or any other arrangement that generates a random series of bytes.

Next, in step 604, the J sequence 218 is combined with the key K 214 by a key generator 224. In this embodiment the key generator 224 is a bitwise exclusive-OR operation schematically illustrated as operation 222. After the key has been modified by the key generator 224, then the modified key is conveyed to the encryption algorithm 208 by some conventional mechanism illustrated schematically by arrow 226 and as set forth in step 606. Counter mode block cipher processing is then applied as described above with respect to FIG. 1. The process then ends in step 608.

The modified counter mode retains the good properties of counter mode operation, namely, conservatism and seekability. Moreover, modified counter mode adds security to normal counter mode operation. Since every message is encrypted with a new key (the key K exclusive-ORed with the random sequence J), the XOR attack, mentioned above, is defeated. Modified counter mode does have the slight disadvantage that its initialization vector (I∥J) is larger than the initialization vector required for normal counter mode. That may be a disadvantage for some applications.

In addition, since the key 214 is modified (via the XOR operation, Kˆ J), the modified counter mode also may, theoretically, be susceptible to a “related key” attack. Related-key cryptanalysis assumes that the attacker learns the encryption of the same (or related) plaintext not only under the original (unknown) key K, but also under other keys derived from (or related to) the unknown key. That attack will be infeasible for many block ciphers and virtually all modern block ciphers are designed to resist related-key attacks. Even if the underlying block cipher 208 is susceptible to a related key attack, the attack will be infeasible in many environments. For example, the attack may only be practical if the attacker has access to an encryption oracle, which virtually never happens in practice.

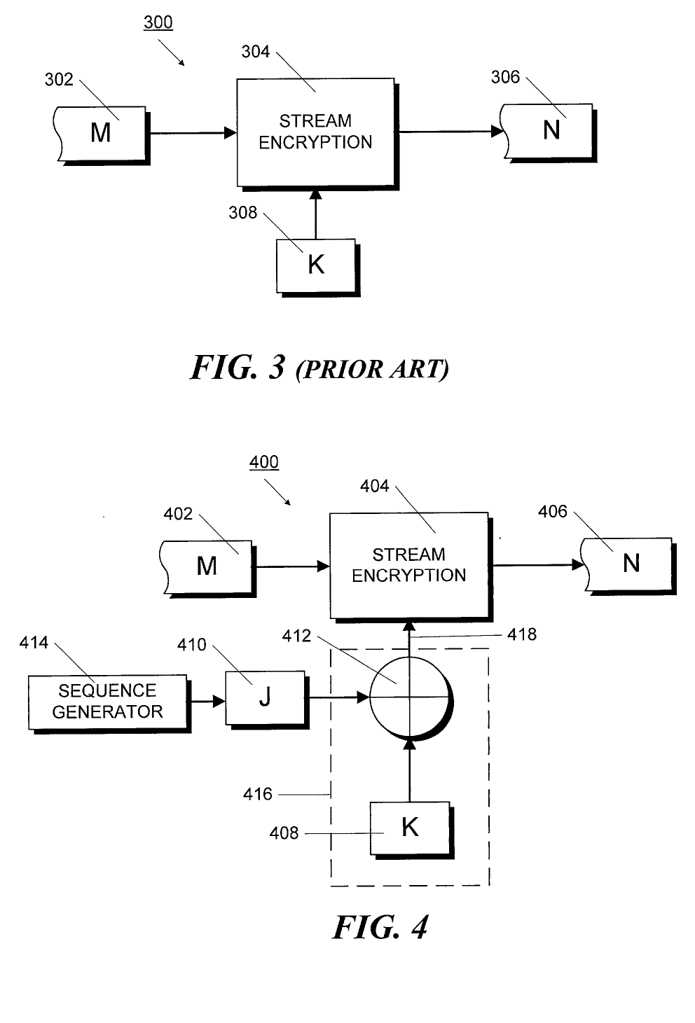

An alternative to a block cipher is a stream cipher. Stream ciphers do not process a block of text. Instead, stream ciphers map a “stream” of bytes of plaintext to the same number of bytes of ciphertext, and vice versa. The stream may be of any length. This prior art arrangement 300 is illustrated in FIG. 3. In this case, a stream of input bytes of which a portion 302 is shown is entered into a stream encryption algorithm 304 that encrypts the stream with a secret key 308. The encryption is performed by any well-known stream encryption algorithm 304 such as RC4 or Seal. The result is a stream of encrypted bytes of which a portion 306 is shown.

In a second embodiment, the technique of modifying the fixed secret key 308 with a variable, non-secret initialization vector can be used with stream ciphers. This is illustrated in FIG. 4. In FIG. 4, elements that correspond to elements in FIG. 3 have been given corresponding numeral designations. For example, stream encryption algorithm 304 in FIG. 3 corresponds to encryption algorithm 404 in FIG. 4. The key modification sequence is the same as illustrated in FIG. 6 in connection with FIG. 3.

Specifically, in a block-like modified stream cipher 400, called stream “block mode”, a random byte sequence 410 of keysize acts as an initialization vector. The byte sequence 410 is randomly generated anew for each message by a sequence generator 414 which can be similar to the sequence generator 220 discussed previously in connection with FIG. 2. The sequence 410 is combined with the secret, fixed key 408 by a key generator 416. In this embodiment, the key generator 416 is an exclusive-OR operation illustrated as 412. The modified key is then conveyed to the encryption algorithm 404 by a conventional mechanism schematically illustrated by arrow 418.

The initialization vector 410 (J) must be communicated between communicating parties, which is a disadvantage compared to the raw stream cipher. However, the use of the initialization vector makes the stream cipher into a stateless cipher (since a different key is used for every encryption), which is a major advantage. Theoretically, stream block mode may also be susceptible to a related key attack, though modern stream ciphers are designed to be resistant to such attacks.

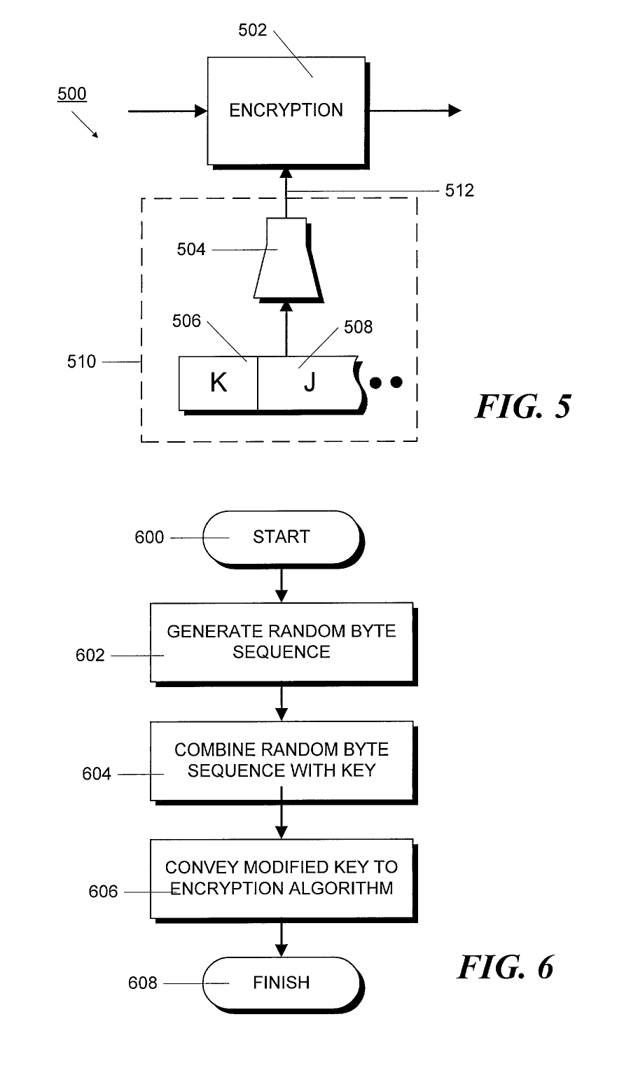

In the foregoing embodiments, the modified counter mode and stream block mode derive a new key from the secret, fixed key K and the initialization vector J (where J has keysize) by a mathematical combination such as a bitwise exclusive-OR operation: Kˆ J. In another embodiment 500 illustrated in FIG. 5, a vector 508 (J) of arbitrary size can be used with a mask generation function 504. A mask generation function, such as function 504, takes as an input a byte array of any length, and produces as output another byte array of a predetermined length. A particular example of such a mask generation function is PBKDF2 (Password-Based Key Derivation Function number 2). This function is defined in the Public Key Cryptographic Standards #5v2.0, section 5.2 available at http://www.rsasecurity.com/rsalabs/pkcs/pkcs-5/index.html.

Then, given a secret, fixed key 506 (K) with a keysize and an initialization vector 508 (J) where J has any length, a keysize array can be formed by key generator 510 by concatenating K and J and using the concatenation as an input to the mask generation function 504 to produce a modified key. The modified key can then be used with the modified counter mode and the stream block mode described above by conveying the key to one of the encryption functions 502 described above as indicated by arrow 512. This latter modified key has the advantage that the size of J is arbitrary, so that applications, which are disadvantaged by the use of a keysize J initialization vector described previously can now operate with a smaller initialization vector.

In still another embodiment, the mask generation function 504 is a “oneway” function. A one-way function has the property that, given the output of the function, it is computationally infeasible to find the input. The use of this one-way function has the advantage that it thwarts the above-mentioned related key attack (in the rare case where the underlying cipher was not resistant to related key attack in the first place).

Although exemplary embodiments of the invention have been disclosed, it will be apparent to those skilled in the art that various changes and modifications can be made which will achieve some of the advantages of the invention without departing from the spirit and scope of the invention. For example, it will be obvious to those reasonably skilled in the art that, in other implementations different encryption techniques and initialization vectors can be used. Other aspects as well as other modifications to the inventive concept are intended to be covered by the appended claims

What is claimed is:

1. A method for improving the security of a counter mode block cipher that breaks a message into text bytes and encrypts each text byte with a fixed, secret key with a keysize, the method comprising:
(a) generating a random byte sequence for each message;
(b) combining the random byte sequence with the key to form a modified key; and
(c) conveying the modified key to the block cipher so that each text byte is encrypted with the modified key.

2. The method of claim 1 wherein the random byte sequence has same size as the keysize and step (b) comprises combining the random byte sequence with the key with a bitwise exclusive-OR function.

3. The method of claim 1 wherein step (b) comprises concatenating the random byte sequence with the key and passing the concatenation through a mask generation function to obtain the modified key.

4. The method of claim 1 wherein the random byte sequence is non-secret.

5. The method of claim 1 wherein the mask generation function is a one-way function.

6. Apparatus for improving the security of a counter mode block cipher that breaks a message into text bytes and uses an encryption algorithm to encrypt each text byte with a fixed, secret key with a keysize, the apparatus comprising:
a sequence generator that generates a random byte sequence for each message;
a key generator that combines the random byte sequence with the key to form a modified key; and
a mechanism that conveys the modified key to the encryption algorithm so that each text byte is encrypted with the modified key.

7. The apparatus of claim 6 wherein the random byte sequence has same size as the keysize and the key generator comprises a bitwise exclusive-OR function that combines the random byte sequence with the key.

8. The apparatus of claim 6 wherein the key generator comprises a mechanism that concatenates the random byte sequence with the key and a mask generation function that operates on the concatenation to obtain the modified key.

9. The apparatus of claim 6 wherein the random byte sequence is non-secret.

10. The apparatus of claim 6 wherein the mask generation function is a one-way function.

11. A method for improving the security of a stream cipher that encrypts a continuous byte stream of messages with a fixed, secret key with a keysize, the method comprising:
(a) generating a random byte sequence for each message;
(b) combining the random byte sequence with the key to form a modified key; and
(c) conveying the modified key to the stream cipher so that each message stream is encrypted with the modified key.

12. The method of claim 11 wherein the random byte sequence has same size as the keysize and step (b) comprises combining the random byte sequence with the key with a bitwise exclusive-OR function.

13. The method of claim 11 wherein step (b) comprises concatenating the random byte sequence with the key and passing the concatenation through a mask generation function to obtain the modified key.

14. The method of claim 11 wherein the random byte sequence is non-secret.

15. The method of claim 11 wherein the mask generation function is a one-way function.

16. Apparatus for improving the security of a stream cipher that encrypts a continuous byte stream of messages with a fixed, secret key with a keysize, the apparatus comprising:
a sequence generator that generates a random byte sequence for each message;
a key generator that combines the random byte sequence with the key to form a modified key; and
a mechanism that conveys the modified key to the encryption algorithm so that each message stream is encrypted with the modified key.

17. The apparatus of claim 16 wherein the random byte sequence has same size as the keysize and the key generator comprises a bitwise exclusive-OR function that combines the random byte sequence with the key.

18. The apparatus of claim 16 wherein the key generator comprises a mechanism that concatenates the random byte sequence with the key and a mask generation function that operates on the concatenation to obtain the modified key.

19. The apparatus of claim 16 wherein the random byte sequence is non-secret.

20. The apparatus of claim 16 wherein the mask generation function is a one-way function.

21. A computer program product for improving the security of a stream cipher that encrypts a continuous byte stream of messages with a fixed, secret key with a keysize, the computer program product comprising a computer usable medium having computer readable code thereon, including:
program code that generates a random byte sequence for each message;
program code that combines the random byte sequence with the key to form a modified key; and
program code that conveys the modified key to the stream cipher so that each message stream is encrypted with the modified key.

22. The computer program product of claim 21 wherein the random byte sequence has same size as the keysize and the program code that generates a random byte sequence comprises program code that combines the random byte sequence with the key with a bitwise exclusive-OR function.

23. The computer program product of claim 21 wherein the program code that generates a random byte sequence comprises program code that concatenates the random byte sequence with the key and passes the concatenation through a mask generation function to obtain the modified key.

24. The computer program product of claim 21 wherein the random byte sequence is non-secret.

25. The computer program product of claim 21 wherein the mask generation function is a one-way function.

26. A computer program product for improving the security of a counter mode block cipher that breaks a message into text bytes and uses an encryption algorithm to encrypt each text byte with a fixed, secret key with a keysize, the computer program product comprising a computer usable medium having computer readable code thereon, including:
program code that generates a random byte sequence for each message;
program code that combines the random byte sequence with the key to form a modified key; and
program code that conveys the modified key to the block cipher so that each text byte is encrypted with the modified key.

27. The computer program product of claim 26 wherein the random byte sequence has same size as the keysize and the program code that generates a random byte sequence comprises program code that combines the random byte sequence with the key with a bitwise exclusive-OR function.

28. The computer program product of claim 26 wherein the program code that generates a random byte sequence comprises program code that concatenates the random byte sequence with the key and passes the concatenation through a mask generation function to obtain the modified key.

29. The computer program product of claim 26 wherein the random byte sequence is non-secret.

30. The computer program product of claim 26 wherein the mask generation function is a one-way function.

31. A computer data signal embodied in a carrier wave for improving the security of a stream cipher that encrypts a continuous byte stream of messages with a fixed, secret key with a keysize, the computer data signal comprising:
program code that generates a random byte sequence for each message;
program code that combines the random byte sequence with the key to form a modified key; and
program code that conveys the modified key to the stream cipher so that each message stream is encrypted with the modified key.

32. A computer data signal for improving the security of a counter mode block cipher that breaks a message into text bytes and uses an encryption algorithm to encrypt each text byte with a fixed, secret key with a keysize, the computer data signal comprising:
program code that generates a random byte sequence for each message;
program code that combines the random byte sequence with the key to form a modified key; and
program code that conveys the modified key to the block cipher so that each text byte is encrypted with the modified key.
